(19) United States
(12) Patent Application Publication
(10) Pub. No.: US 2015/0142642 A1
(43) Pub. Date: May 21, 2015

(54) DETECTING PAYMENT LAYERING THROUGH CORRESPONDENT BANKS

(71) Applicant: Bank of America Corporation, Charlotte, NC (US)

(72) Inventors: Carl Suplee, Hunterville, NC (US); Cameron Blake Hughes, Charlotte, NC (US); Jun Zhou, Charlotte, NC (US); Xiaowei Ying, Charlotte, NC (US)

(73) Assignee: Bank of America Corporation, Charlotte, NC (US)

(21) Appl. No.: 14/085,636

(22) Filed: Nov. 20, 2013

(51) Int. Cl. G06Q 40/02

(52) U.S. Cl. CPC G06Q 40/02
USPC 705/39

(57) ABSTRACT

In some embodiments, a system comprises an interface and one or more processors. The interface receives transaction information for one or more transactions performed using resources of a first financial institution. The processors determine that an originating party associated with the transactions is not a customer of the first financial institution and the originating party is a customer of a second financial institution. The second financial institution is authorized to facilitate access to the resources of the first financial institution. The processors assign a unique identifier to the originating party, associate the transactions with the unique identifier, and monitor the transactions based on a policy that the first financial institution applies to its own customers. in response to detecting suspicious activity, the processors generate an alert and the interface communicates the alert.

### TECHNICAL FIELD OF THE INVENTION

This invention relates generally to monitoring techniques, and more particularly to detecting payment layering through correspondent banks.

### BACKGROUND

A financial institution processes deposit, withdrawal, and/or other transactions initiated by its customers. If a customer has obtained money through illegitimate means, the customer may attempt to conduct payment layering or other money laundering techniques to avoid detection. Payment layering occurs when the customer attempts to camouflage illegitimate income within a series of complex financial transactions involving both legitimate income and illegitimate income, The complex financial transactions may include payment structuring. Payment structuring occurs when the customer divides one large transaction into multiple small transactions in order to avoid detection. The customer may divide the large transaction into multiple small transactions that each transact a monetary amount less than the amounts specified in governmental reporting requirements. As an example, laws may require the financial institution to file a currency transaction report (CTR) if a transaction (or a series of related transactions) exceeds a set dollar amount, such as $10,000 per day. A customer may attempt to avoid having a CRT tiled by structuring a series of transactions in the amount of $9,000 each over the course of several consecutive days. If detected, the financial institution may report payment structuring and any other payment layering transactions as suspicious.

### SUMMARY

According to embodiments of the present disclosure, disadvantages and problems associated with detecting payment layering through correspondent banks may be reduced or eliminated.

In some embodiments, a system comprises an interface and one or more processors. The interface receives transaction information for one or more transactions performed using resources of a first financial institution. The processors determine that an originating, party associated with the transactions is not a customer of the first financial institution and the originating party is a customer of a second. financial institution. The second financial institution is authorized to facilitate access to the resources of the first financial institution. The processors assign a unique identifier to the originating party, associate the transactions with the unique identifier, and monitor the transactions based on a policy that the first financial institution applies to its own customers. In response to detecting suspicious activity, the processors generate an alert and the interface communicates the alert.

Certain embodiments of the present disclosure may provide one or more technical advantages. A technical advantage of one embodiment includes accurately and efficiently detecting payment layering through correspondent banks. For example, certain embodiments may assign a unique identifier to a non-customer that accesses a financial institution's resources through a correspondent bank. The financial institution uses the unique identifier to monitor transactions by the non-customer. Thus, the financial institution may detect when the non-customer uses the financial institution's resources to make suspicious transactions. A technical advantage of one embodiment includes comparing the non-customer's current and historic behavior to determine whether a suspicious change in behavior has occurred. One or more other technical advantages may be readily apparent to those skilled in the art from the figures, descriptions, and claims included herein.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of a system for detecting payment layering through correspondent banks;

FIG. 2 illustrates an example flowchart for detecting payment layering through correspondent banks;

FIG. 3 illustrates an example flowchart for applying weighting factors to detect payment layering through correspondent banks; and

FIG. 4 illustrates an example of a transaction history to which monitoring may be applied in order to detect payment layering,

### DETAILED DESCRIPTION OF THE DRAWINGS

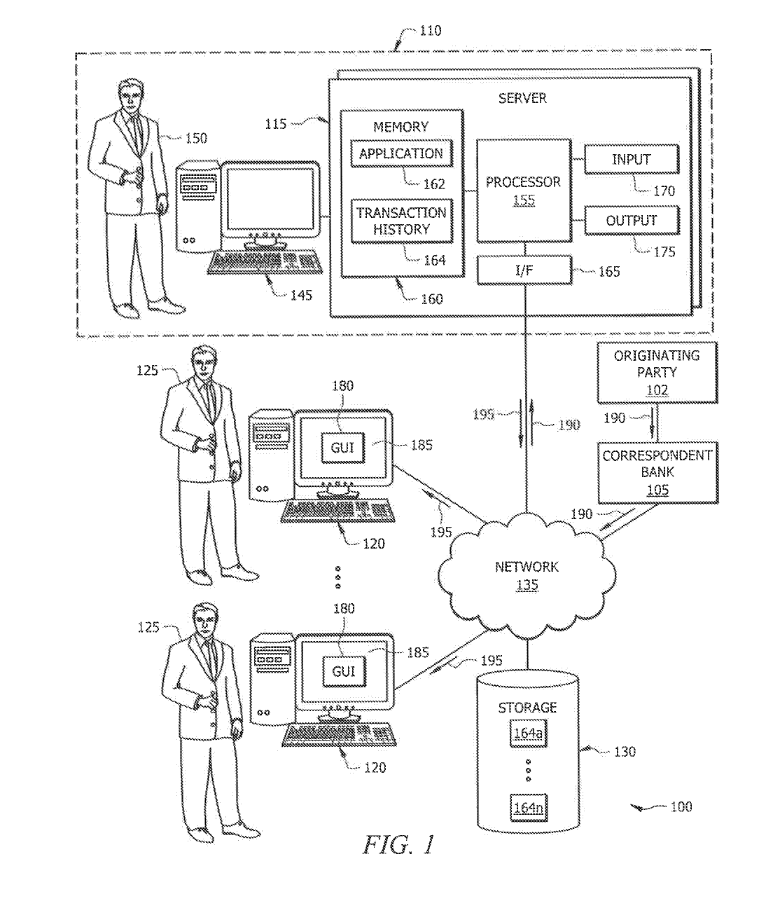

Embodiments of the present invention and its advantages are best understood by referring to FIGS. 1 through 4 of the drawings, like numerals being used for like and corresponding parts of the various drawings.

A financial institution processes deposit, withdrawal, and/or other transactions initiated by its customers. If a customer has obtained money through illegitimate means, the customer may attempt to conduct payment layering or other money laundering techniques to avoid detection. Payment layering occurs when the customer attempts to camouflage illegitimate income within a series of complex financial transactions involving both legitimate income and illegitimate income. The complex financial transactions may include payment structuring. Payment structuring occurs when the customer divides one large transaction into multiple small transactions in order to avoid detection. The customer may divide the large transaction into multiple small transactions that each transact a monetary amount less than the amounts specified in governmental reporting requirements. As an example, laws may require the financial institution to file a currency transaction report (CTR) if a transaction (or a series of related transactions) exceeds a set dollar amount, such as $10,000 per day. A customer may attempt to avoid having a CRT filed by structuring a series of transactions in the amount of $9,000 each over the course of several consecutive days. If detected, the financial institution may report payment structuring and any other payment layering transactions as suspicious.

Conventional techniques for detecting payment layering fail to adequately monitor suspicious activity of non-customers. Non-customers may access a financial institution's resources through a correspondent bank that is itself a customer of the financial institution. For example, Bank A may have Bank B as a customer. Bank B may have its own customers, such as Party X, who is not a customer of Bank A. Party X may perform deposits, withdrawals, and other transactions with Bank B. Bank B may in turn use resources of Bank A to complete the transactions on behalf of Party X. Because Party X is not a customer of Bank A, Bank A may have limited information about Party X. Thus, suspicious activity conducted by Party X may be difficult to detect. To address this and other problems, embodiments of the present invention allow for assigning a unique identifier to Party X (Bank A's customer's customer) so that Bank A can monitor transactions for suspicious activity transacted using resources of Bank A.

FIG. 1 illustrates an example block diagram of a system 100 for detecting payment layering through correspondent banks. System 100 may include an originating party 102, a correspondent bank 105, an enterprise 110 comprising one or more servers 115, one or more clients 120 associated with one or more users 125, and a network storage device 130. Correspondent bank 105, enterprise 110, servers 115, clients 120, and network storage device 130 may be communicatively coupled by a network 135. in general, correspondent bank 105 facilitates transactions that use resources of enterprise 110. Correspondent bank 105 receives transaction information 190 from originating party 102 and communicates transaction information 190 to a server 115 of enterprise 110. Server 115 parses transaction information 190 to determine originating party 102. Server 115 assigns a unique identifier to originating party 102 and uses the unique identifier to monitor transactions of originating party 102. if originating party 102 participates in suspicious transactions, server 115 communicates an alert 195 to users 125 via client 120.

Client 120 may refer to any device that enables user 125 to interact with server 115. In some embodiments, client 120 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 120 may also comprise any suitable user interface such as a display 185, microphone, keyboard, or any other appropriate terminal equipment usable by a user 125. It will be understood that system 100 may comprise any number and combination of clients 120. User 125 utilizes client 120 to interact with server 115 to receive alert 195, as described below. In some embodiments, user 125 may be an employee of a financial institution (e.g., enterprise 110), an investigative business, or a governmental entity that monitors transactions to detect transaction structuring, payment layering, or other suspicious transactions.

In some embodiments, client 120 may include a graphical user interface (GUI) 180, GUI 180 is generally operable to tailor and filter data entered by and presented to user 125. GUI 180 may provide user 125 with an efficient and user-friendly presentation of transaction information 190 and/or alert 195. GUI 180 may comprise a plurality of displays having interactive fields, pull-down lists, and buttons operated by user 125. GUI 180 may include multiple levels of abstraction including groupings and boundaries. It should be understood that the term GUI 180 may be used in the singular or in the plural to describe one or more GUIs 180 and each of the displays of a particular GUI 180.

In some embodiments, network storage device 130 may refer to any suitable device communicatively coupled to network 135 and capable of storing and facilitating retrieval of data and/or instructions, Examples of network storage device 130 include computer memory (for example, Random Access Memory (RAM) or Read Only Memory (ROM), mass storage media. (for example, a hard disk), removable storage media (for example, a Compact Disk (CD) or a Digital Video Disk (DVD), database and/or network storage (for example, a server), and/or or any other volatile or non-volatile, non-transitory computer-readable memory devices that store one or more files, lists, tables, or other arrangements of information. Network storage device 130 may store any data and/or instructions utilized by server 115.

In the illustrated embodiment, network storage device 130 stores transaction history 164. Transaction history 164 may include data describing previous transactions by originating party 102. For each transaction, transaction history 164 may include one or more of a unique identifier for originating party 102, transaction number, correspondent bank name, originating party name, originating party identifier (e.g., an account number or other identifier that correspondent bank 105 associates with the originating party), beneficiary party name, beneficiary party identifier (e.g., an account number or other identifier that correspondent bank 105 associates with the beneficiary party), transaction date, transaction location, transaction method (e.g., bank branch, ATM, online, wire, cash, etc.), transaction type (e.g., deposit, withdrawal), dollar amount, report indicator that indicates whether or not a CRT or other report was filed on the transaction, and/or other suitable information. Transaction history 164 may be analyzed to determine whether to generate alert 195 for originating party 102. For example, alert 195 may be generated if transaction history 164 shows a suspicious increase in the frequency and/or monetary amounts transacted between originating party 102 and a particular beneficiary party.

In certain embodiments, network 135 may refer to any interconnecting system capable of transmitting audio, video, signals, data, messages, or any combination of the preceding. Network 135 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, correspondent bank 105 may refer to a financial institution such as a bank. Correspondent bank 105 may be a customer of enterprise 110—enterprise 110 may refer to another financial institution, such as another bank. Originating party 102 may be an individual or business that is a customer of correspondent bank 105 and not a customer of enterprise 110. Correspondent bank 105 may facilitate transactions on behalf of originating party 102 using resources of enterprise 110. As an example, correspondent bank. 105 may facilitate an electronic funds transfer (EFT) from originating party 102 to a beneficiary party using enterprise 110's wires.

In some embodiments, enterprise 110 may include one or more servers 115, an administrator workstation 145, and an administrator 150. In some embodiments, server 115 may refer to any suitable combination of hardware and/or software implemented in one or more modules to process data and provide the described functions and operations. in some embodiments, the functions and operations described herein may be performed by a pool of servers 115. In some embodiments, server 115 may include, for example, a mainframe, server, host computer, workstation, web server, file server, a personal computer such as a laptop, or any other suitable device operable to process data. in some embodiments, server 115 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, servers 115 receive transaction information 190 for one or more transactions associated with originating party 102, determine that originating party 102 is not a customer of enterprise 110 and is a customer of correspondent bank 105, assign a unique identifier to originating party 102, and use the unique identifier to identify transactions of originating party 102. Servers 115 may then monitor originating party 102's transactions for potentially suspicious activity. If servers 115 detect potentially suspicious activity, such as activity consistent with payment layering, servers 115 may communicate alert 195 to users 125 via client 120.

In some embodiments, servers 115 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and, or network storage (for example, a server), and/or or any other volatile or non-volatile, non-transitory computer-readable memory devices that store one or more files, lists, tables, or other arrangements of information. Although FIG. 1 illustrates server memory 160 as internal to server 115, it should be understood that server memory 160 may be internal or external to server 115, depending on particular implementations. Also, server memory 160 may be separate from or integral to other memory devices to achieve any suitable arrangement of memory devices for use in system 100.

Server memory 160 is generally operable to store an application 162 and transaction history 164. Application 162 generally refers to logic, rules, algorithms, code, tables, and/or other suitable instructions for performing the described functions and operations. In some embodiments, application 162 facilitates generating alert 195 and communicating alert 195 to users 125.

Server memory 160 communicatively couples to processor 155. Processor 155 is generally operable to execute application 162 stored in server memory 160 to provide alert 195 according to the disclosure. Processor 155 may comprise any suitable combination of hardware and software implemented in one or more modules to execute instructions and manipulate data to perform the described functions for servers 115. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 115, send output from server 115, perform suitable processing of the input or output or both, communicate to other devices, or any combination of the preceding. Communication interface 165 may include appropriate hardware (e.g. modem, network interface card, etc.) and software, including protocol conversion and data processing capabilities, to communicate through network 135 or other communication system that allows server 115 to communicate to other devices. Communication interface 165 may include any suitable software operable to access data from various devices such as clients 120 and/or network storage device 130. Communication interface 165 may also include any suitable software operable to transmit data to various devices such as clients 120 and/or network storage device 130. Communication interface 165 may include one or more ports, conversion software, or both. In general, communication interface 165 receives transaction information 190 from correspondent bank 105 and transmits alert 195 to clients 120.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 115 using an administrator workstation 145. In some embodiments, administrator workstation 145 may be communicatively coupled to server 115 and may refer to any suitable computing system, workstation, personal computer such as a laptop, or any other device operable to process data. In certain embodiments, an administrator 150 may utilize administrator workstation 145 to manage server 115 and any of the data stored in server memory 160 and/or network storage device 130.

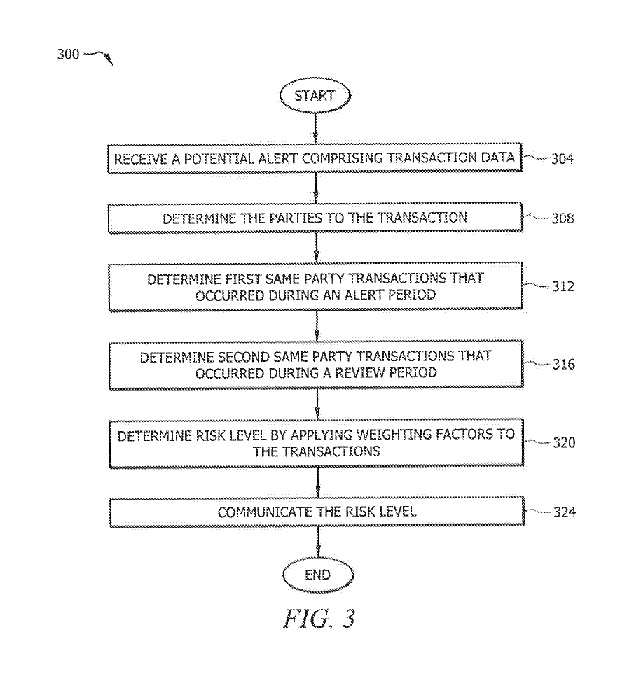

In operation, application 162, upon execution by processor 155, facilitates generating alert 195 and communicating alert 195 to users 125. Alert 195 indicates that originating party 102 has conducted transactions that raise a suspicion of payment layering. In some embodiments, application 162 may use a policy that enterprise 110 applies to its own customers to determine whether to generate alert 195 for a non-customer, such as originating party 102, An example of a policy that may be used by application 162 is described in more detail with respect to FIG. 3 below. In general, the policy described below generates alert 195 upon a determination that there is a sufficiently high risk level (e.g., if the risk level exceeds a pre-determined threshold). The risk level may be determined according to one or more weighting factors. In some embodiments, the weighting factors may increase the risk level if the transaction is part of a pattern of activity consistent with payment layering. Conversely, the weighting factors may decrease the risk level if the transaction is not part of a pattern of activity consistent with payment layering. As used herein, decreasing the risk level may refer to lowering the risk level or keeping the risk level the same (i.e., not increasing the risk level).

To provide alert 195, application 162 may first receive transaction information 190 from correspondent bank 1050 Transaction information 190 may include one or more of a transaction number, correspondent bank name, originating party name, originating party identifier (e.g., an account number or other identifier that correspondent bank 105 associates with the originating party), beneficiary party name, beneficiary party identifier (e.g., an account number or other identifier that correspondent bank 105 associates with the beneficiary party), transaction date, transaction location, transaction method (e.g., bank branch, ATM, online, wire, cash, etc.), transaction type (e.g., deposit, withdrawal), dollar amount, and/or other suitable information.

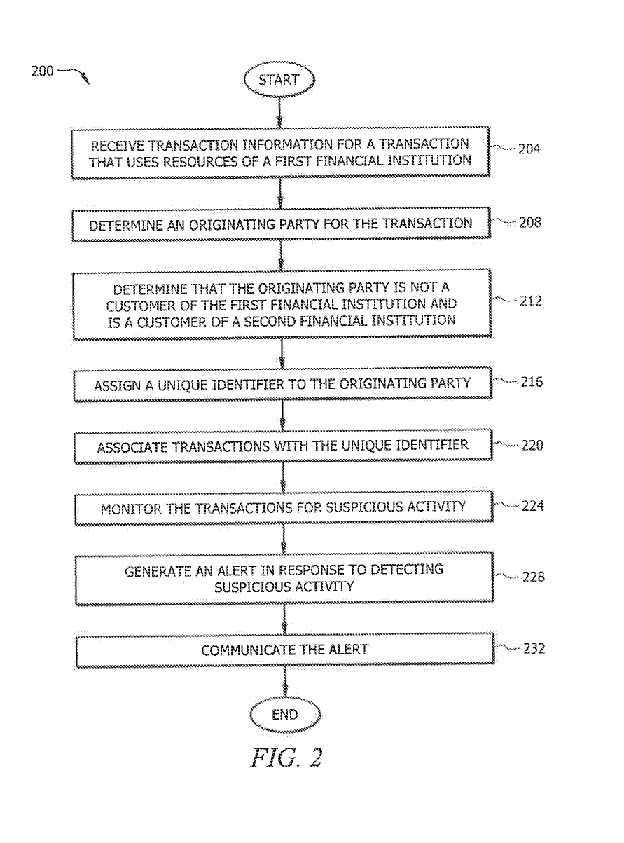

Once application 162 receives transaction information 190, application 162 may determine whether or not to generate alert 195. In general application 162 may determine originating party 102 associated with transaction information 190. For example, application 162 may determine that originating party 102 is not a customer of enterprise 110 and is a customer of correspondent bank 105, assign a unique identifier to originating party 102, and use the unique identifier to identify transactions of originating party 102 (such as other transactions of originating party 102 contained in transaction history 164). Application 162 may then monitor originating party 102's transactions for potentially suspicious activity. If application 162 detects potentially suspicious activity associated with originating party 102, such as activity consistent with payment layering, application 162 may generate alert 195 to communicate to users 125 via client 120. FIG. 2 below provides a detailed example of a method that application 162 may perform to determine whether or not to Generate alert 195.

FIG. 2 illustrates an example of a method 200 for detecting payment layering through correspondent banks. The method begins at step 204 by receiving transaction information for a transaction that uses resources of a first financial institution, such as enterprise 110 of FIG. 1. For purposes of the example, the first financial institution may be referred to as “Bank A.” The transaction information received by Bank A may include one or more of a transaction number, correspondent bank name, originating party name, originating party identifier (e.g., an account number or other identifier that a second financial institution associates with the originating party), beneficiary party name, beneficiary party identifier (e.g., an account number or other identifier that the second financial institution associates with the beneficiary party), transaction date, transaction location, transaction method (e.g., bank branch, ATM, online, wire, cash, etc.), transaction type (e.g., deposit, withdrawal), dollar amount, and/or other suitable information.

At step 208, the method determines an originating party associated with the transaction. The method may use the originating party name, originating party identifier, and/or other information contained in the transaction information to determine the originating party for the transaction. As an example, the method may determine that “Party X” is the originating party for the transaction,

The method may determine Party X's relationship to the Bank A at step 212. For example, the relationship may be that of customer's customer. That is, at step 212, it may be determined that Party X is not a customer of the Bank A, but Party X is a customer of Bank A's customer, Bank B. For purposes of the example, Bank B may be a second financial institution, such as correspondent bank 105 of FIG. 1, that facilitates transactions that use resources of Bank A. The method may determine that Party X is a customer of Bank B and is not a customer of Bank A using records kept by Bank A, information in the transaction information, or any other suitable information. As an example, if the transaction information includes a correspondent bank name (Bank B), the method may determine that Party X is not a customer of Bank A and is a customer of correspondent Bank B.

At step 216, the method assigns a unique identifier to Party X. In some embodiments, a portion of the unique identifier indicates that the originating party is a customer of Bank B. For example, the unique identifier may be BBB-XXXX where “BBB” indicates that the party is a customer of Bank B and “XXXX” specifies the particular customer of Bank B (Party X). In alternative embodiments, the unique identifier need not include a portion indicating that the originating party is a customer of Bank B. Thus, any suitable identifier comprising any suitable number and combination of characters may be used. In sonic embodiments, Party X may be a customer of more than one correspondent bank 105, such as correspondent Bank B and also correspondent Bank C. Party name or other identifying information may be used to assign the same unique identifier to transactions facilitated by Party X through either Bank B or Bank C. This may allow Bank A to collectively monitor all of the transactions that Party X transacts using Bank A's resources regardless of whether Party X initiated the transactions from Bank B or Bank C.

The method associates transactions with the unique identifier at step 220. For example, the method may monitor transaction history and/or incoming transactions in which customers of Bank B access resources of Bank A. The method may determine a party name for each of the transactions, and may associate the transaction with the unique identifier BBB-XXX if the party name corresponds to Party X. In addition, in some embodiments, the method may store the unique identifier BBB-XXX and assign it to any future transactions associated with Party X.

At step 224, the method monitors transactions associated with the unique identifier BBB-XXXX based on a policy that Bank A applies to its own customers. That is, a policy applied to Party X may be the same as or similar to the policy that Bank A applies to its own customers. A similar policy may omit certain. rules (e.g., if information checked by the rule is unknown because Party X is a non-customer), add certain rules (e.g., to include checks unique to a non-customer), and/or adjust the configuration settings associated with the rules (e.g., a rule may be configured to generate an alert if a party transacts more than $X per day, where the value of X depends on whether the party is a customer or a non-customer).

The policy may be configured to analyze a subset of Party X's transactions that were transacted with the same beneficiary party, such as Party Y, and that occurred during an alert period. In some embodiments, the alert period may he determined dynamically according to a number of consecutive business days that transactions were transacted between the originating party and the same beneficiary party. For example, if transactions between Party X and Party Y occurred on Friday June 1; Monday June 4; Tuesday June 5; and Friday June 8, the alert period may be dynamically determined to be June 1 through June 5 which encompasses each of the transactions that occurred on consecutive business days and excludes the transaction for which there was at least one intervening consecutive business day (e.g., June 6 and June 7 correspond to intervening consecutive business days during which no transactions were transacted between Party X and Party Y).

The policy may be configured to detect suspicious activity using any suitable criteria. In some embodiments, the policy may detect suspicious activity if an aggregate monetary value associated with the subset of transactions between Party X and Party Y during the alert period exceeds an alert threshold. As an example, the alert threshold may be set to a CRT reporting limit, such as $10,000. If Party X and Party Y transact a $9,000 transaction on June 4 and a $9,500 transaction on June 5, the aggregate monetary value transacted during the alert period ($18,500) would exceed the alert threshold ($10,000). This activity may be detected as suspicious because it may suggest that the parties are trying to avoid the reporting requirement.

As another example, the policy may detect suspicious activity if a frequency of transactions between Party X and Party Y during the alert period exceeds a frequency of transactions between Party X and Party Y during a review period by a pre-determined factor (X), In some embodiments, X may be set to 3.6 and the review period may be set to 2 months. The method may compare the average number of transactions between the Party X and Party Y per day during the alert period to the average number of transactions between Party X and Party Y per day during the review period. For example, if the parties average 10 transactions per day during the alert period and 2 transactions per day during the review period, the activity during the alert period may be detected as suspicious activity (i.e., 10>3.6×2).

As another example, the policy may detect suspicious activity if an average monetary amount transacted between the originating party and the same beneficiary party per an averaging period during the alert period exceeds an average monetary amount transacted between the originating party and the same beneficiary party per the averaging period during the review period by a second pre-determined factor (Y). In some embodiments, the averaging period could be one day, the review period could be 2 months, and Y could be 3. If Party X and Party Y transacted $20,000 per day during the alert period and $5,000 per day during the review period, then the activity during the alert period may be detected as suspicious activity (i.e., $20,000>3×$5,000).

At step 228, the method generates an alert in response to detecting suspicious activity. An alert may be generated in response to detecting a single suspicious activity or, in the alternative, in response to detecting a combination of suspicious activities. For example, on its own, activity in which the aggregate amount of the transactions exceeds the alert threshold may not cause an alert to be generated. However, this activity in combination with other suspicious activity (e.g., an increase in the average dollar amounts and/or frequency of transactions between Party X and Party B as compared to historic averages of the parties) may cause an alert to be generated. In some embodiments, an alert may be suppressed in response to activity that mitigates the risk of otherwise suspicious activity. For example, if a recent transaction between Party X and Party Y exceeded a reportable monetary amount, it may suggest that the parties are not trying to avoid reporting requirements such that an alert need not be generated. In some embodiments, an alert may be generated if, after applying a plurality of weighting factors, a determination is made that a risk level exceeds a risk threshold. Examples of weighting factors are described in more detail with respect to FIG. 3 below.

At step 232, the method communicates the alert. The alert may comprise any suitable information, such as information associated with the originating party, the beneficiary party, and/or the transactions that caused the alert to be generated. The method then ends.

FIG. 3 illustrates an example of a method 300 for determining a risk level. The risk level may be used to facilitate the detection of suspicious activity, such as transaction structuring and/or payment layering. The method begins at step 304 by receiving a potential alert comprising transaction information (as described above).

In some embodiments, the method may perform a preliminary assessment to check whether or not it is necessary to determine the risk level for the transaction. As an example, the preliminary assessment may decide it is not necessary to determine the risk level if the dollar amount of the transaction is high enough to trigger a reporting requirement. That is, the filing of a report suggests that the parties did not intend to avoid the reporting requirement. As another example, the preliminary assessment may decide that it is not necessary to determine the risk level if the dollar amount is less than a minimum monetary amount. The minimum monetary amount may be set relative to the reporting limit in order to generate alerts for transactions with a higher likelihood of being structured (e.g., transactions just under the reporting limit) without generating unnecessary alerts for transactions that are less likely to be structured (e.g., transactions well below the reporting limit). In some embodiments, the minimum monetary amount to proceed with determining the risk level may be set to 10%, 20%, 30%, 40%, 50%, or other suitable percentage of the reporting requirement. For example, if the reporting requirement is $10,000, the minimum monetary amount may be set to $5,000, which is 50% of the reporting requirement.

If the method decides to determine the risk level for the transaction, the method proceeds to step 308, At step 308, the method determines a first party (Party X) and a second party (Party Y) to the transaction. A party may refer to a person, an entity, an account, or any other party that provides or receives finances through a transaction.

At step 312, the method determines a first subset of same party transactions. The first subset of same party transactions may include some or all of the transactions between the first party and the second party during an alert period. The alert period may refer to a period of time during which the transaction indicated in step 304 is likely to have been structured with other transactions. For example, a party intending to structure transactions may be likely to make three separate $9,000 transactions on three consecutive days. Thus, setting the alert period to monitor transactions occurring over at least three days could assess the three transactions to determine if they demonstrate a pattern of activity consistent with transaction structuring. By contrast, a party intending to structure transactions may be unlikely to wait a prolonged period of time, such as one year, between transacting each installment of the structured transaction. Thus, the alert period may be less than 1 year to limit the number of low risk/unrelated transactions analyzed by the method. Any suitable alert period may be used, such as 2 days, 3 days, 5 days, 1 week, 1 month, or other time period. The alert period may be set to monitor transactions occurring before and/or after the transaction indicated in step 304. In some embodiments, the alert period may be set dynamically, as discussed with respect to FIG. 2 above.

The method determines a second subset of same party transactions in step 316. The second subset of same party transactions may include some or all of the transactions by the first party and/or the second party during a review period. The review period may be selected to provide a historical perspective of typical activity for the parties. The review period may be larger than the alert period. As an example, the review period may be set to 2 months and the alert period may be set to 3 consecutive business days, The method may detect that every day during the alert period, Party X transacted a transaction with Party Y in an amount between $9,000 and $10,000 (e.g., just below a CRT reporting limit). The method may compare transactions between Party X and Party Y during the review period, and may determine that the parties typically transact between $8,000 and $12,000 per day. Based on the historical perspective from the review period, the method may determine that the transaction amounts during the alert period are within typical ranges for the parties and that CRTs have been filed for the parties within the 2 month review period. As a result, the method may conclude the transactions during the alert period have a low risk of being structured. Thus, the review period may be set to any time period selected to provide suitable context to compare against the transactions that occur during the alert period. In some embodiments, the review period may be set to 1 month, 2 months, 6 months, 1 year, or other suitable time period. The review period may be configured to include transactions occurring before and/or after the transaction indicated in step 304.

At step 320, the method determines the risk level according to a plurality of weighting factors. Weighting factors may be applied so that increased risk is assigned to patterns of activity that are consistent with intent to structure transactions and or layer payments. Accordingly, the risk level may be used to efficiently detect money laundering. Examples of weighting factors include a single transaction weighting factor, a frequency weighting factor, an average weighting factor, a total amount weighting factor, a location weighting factor, a non-reported transaction weighting factor, a reported transaction weighting factor, a take-back weighting factor, an even amount weighting factor, an excess consecutive transactions weighting factor, and an aggregate amount weighting factor, as discussed below, Any suitable number and combination of weighting factors may be used.

A single transaction weighting factor may decrease the risk level if a monetary amount of a transaction in the second subset satisfies a low-risk threshold. For example, the low-risk threshold may be set to a value inconsistent with payment structuring between the first party and the second party. As an example, the low-risk threshold could be set to $1,000,000 per single transaction. If the first party intends to disguise a large transaction to the second party by dividing it up into a series of smaller transactions, it may be unlikely that the first party would have transacted any large transaction (e.g., a $1,000,000 single transaction) with the second party during the review period. Thus, if the first party did transact a $1,000,000 single transaction with the second party during the review period, the risk may be decreased.

A frequency weighting factor may increase the risk level if a transaction frequency associated with the first subset of same party transactions exceeds a transaction frequency associated with the second subset of same party transactions by a first pre-determined factor (X). As an example, X may be set to 3.6 and the review period may be set to 2 months. The method may compare the average number of transactions between the first party and second party per day during the alert period to the average number of transactions between the first party and second party per day during the review period. For example, if the parties average 10 transactions per day during the alert period and 2 transactions per day during the review period, then the risk level may be increased (i.e., 10>3.6×2).

An average weighting factor may increase the risk level if an average monetary amount transacted between the parties per an averaging period during the alert period exceeds an average monetary amount transacted between the parties per the averaging period during the review period by a second pre-determined factor (Y). As an example, the averaging period could be one day, the review period could be 2 months, and Y could be 3. If the parties transacted $20,000 per day during the alert period and $5,000 per day during the review period, then the risk level may be increased (i.e., $20,000>3×$5,000). The average weighting factor may mitigate false positives caused by legitimate business practices that involve transactions occurring on a regular basis from the same originator to the same beneficiary, such as broker/dealer relationships or transactions between large corporate entities. In some embodiments, Y may be determined based on a percentile of potential alerts, such as the 25th percentile. In the example, this means Y may be set so that on average 25% of all potential alerts fail to meet the criterion and, therefore, receive an increased risk as a result of applying the average weighting factor.

A total amount weighting factor may increase the risk level if a total monetary amount transacted between the parties during the alert period exceeds a maximum individual monetary amount transacted between the parties during the review period by a third pre-determined factor (Z). The pre-determined factor Z may be set to any suitable number. In some embodiments, Z may be set to capture a certain percentile of transactions, such as the 90th percentile or the 95th percentile of potential alerts generated on originator/beneficiary pairs that have multiple transactions on the same or adjacent days. As an example, the 90th percentile may correspond to a Z factor of 3 and the 95th percentile may correspond to a Z factor of 4.

The total amount weighting factor may identify customers attempting to hide one large transaction by dividing it into multiple smaller transactions without unnecessarily identifying customers that are not attempting to hide large transactions. For example, suppose Party X wires $40,000 to Party Y on each day during an alert period set to five consecutive business days, for a total of $200,000. This may ordinarily set off a payment layering alert. However, if during the review period Party X wires $150,000 to Party Y in a single transaction, Party X and Party Y do not exhibit a pattern of behavior consistent with hiding large transactions. The Z factor may be set such that the total amount weighting factor decreases the risk level for cases like this, As an example, Z may be set to 3. Accordingly, in the preceding example, the total monetary amount transacted between the parties during the alert period ($200,000) is less than $450,000 such that the risk level is decreased. In the example, the $450,000 corresponds to the Z factor (which is set to 3) times the maximum individual monetary amount transacted between the parties during the review period ($150,000).

A location weighting factor may increase the risk level if the first subset of same party transactions were initiated from more than a pre-determined number of locations, For example, if the pre-determined number of locations is set to three, the location weighting factor may increase the risk level if during the alert period Party X wires Party Y $8,000 from a first banking center, $9,000 from a second banking center, and $9,500 from an online account, the location weighting factor may increase the risk.

A non-reported transaction weighting factor may increase the risk level if the monetary amount of one or more of the transactions in the first subset is greater than 80% and less than 100% of a reportable monetary amount, As an example, the reportable monetary amount may correspond to a CRT reporting limit ($10,000), such that the non-reported transaction weighting factor may increase the risk level for same party transactions between $8,000 and $10,000. The non-reported transaction weighting factor may facilitate identifying customers that conduct transactions in amounts slightly below the reporting limit because they intend to avoid having a report filed on the transaction. The non-reported transaction weighting factor may have any suitable percentage as the lower bound, such as 50%, 60%, 70%, 80%, 90%, 95%, or other percentage.

A reported transaction weighting factor may decrease the risk level if a recent transaction between the parties exceeded a reportable monetary amount. A recent transaction may refer to a transaction that occurred within a pre-determined recent time period, such as 1 week, 1 month, 2 months, or other suitable time period. If a report was recently filed on the parties, it suggests the parties do not intend to structure transactions to avoid reporting requirements.

A take-back weighting factor may increase the risk level associated with the first party if the first Party X cancelled a recent transaction that exceeded a reportable monetary amount, wherein the recent transaction occurred within a pre-determined recent time period. A recent transaction may refer to a transaction that occurred within a pre-determined recent time period, such as 1 week, 1 month, 2 months, or other suitable time period. As an example, a take-back may occur when a customer asks a bank teller to initiate a transaction, realizes that the a report will be filed on the transaction, and cancels the transaction to avoid the reporting limit. Canceling the transaction may refer to stopping the transaction or reducing the monetary amount so that it is less than the reporting limit. Take-back behavior suggests that the customer is avoiding the reporting limit.

An even amount weighting factor indicating to increase the risk level if a number of even amount transactions exceeds an even amount threshold, wherein the even amount transactions correspond to transactions in the first subset that have an associated monetary amount ending in a pre-determined number of zeros. This factor may identify transactions having “even” monetary amounts, such as amounts ending in at least two zeros (e.g., $8100, $9200, $10500), transactions ending in at least three zeros (e.g., $8000, $9000, $10000), or other monetary amounts ending in a pre-determined number of zeros. Parties that perform a certain number of even amount transactions may intend to break a large transaction into multiple smaller transactions. For example, it may be convenient for a party to divide an $18,000 transaction into three transactions in the amount of $9,000 each. This behavior would cause the even amount weighting factor to increase the risk level, for example, if the pre-determined number of zeros was set to 3 (or fewer) zeros and the even amount threshold was set to 3 (or fewer) transactions. On the other hand, parties making multiple transactions in non-even amounts, such as $9,583.12. $8,972.34, and $9,413.29, may be more likely to be conducting legitimate business. This behavior would not cause the event amount weighting factor to increase the risk level.

The excess consecutive transactions factor may increase the risk level if the number of transactions during a pre-determined consecutive time period exceeds a maximum consecutive transactions threshold. As an example, the pre-determined consecutive time period may correspond to the same business day or (n) number of consecutive business days (such as one business day) and the maximum consecutive transactions threshold could be set to 5. Thus, if the first party and the second party conduct at least five transactions on the same day or on two consecutive business days, the risk level may be increased.

In some embodiments, the maximum consecutive transactions threshold may be set to increase the risk associated with transactions in a certain percentile of possible potential alerts, such as the 90th percentile or the 95th percentile. As an example, the 90th percentile may correspond to 5 transactions with the same party during the consecutive time period, and the 95th percentile may correspond to 9 or more transactions with the same party during the consecutive time period. Thus, the 90th or 95th percentile may indicate an unusually large number of same party transactions compared to other customers and, thus, may indicate increased risk.

An aggregate amount weighting factor may decrease the risk level if the combined monetary amount of all the same party transactions during the alert period is less than a reporting limit. For example, if during the alert period the parties perform a total of two transactions in the amount of $4,000 each ($8,000 total) it is less likely that they intend to disguise a large transaction by dividing it into several smaller transactions. That is, even if the parties had transacted the $8,000 in a single transaction, the $10,000 CRT reporting limit would not have been met and no report would have been filed.

At step 324, the method communicates the risk level. As an example, the risk level may be communicated to an application configured to determine whether or not to generate an alert. The application may compare the risk level to a risk threshold and generate an alert if the risk level exceeds the risk threshold. In some embodiments, the risk level may be incorporated into the alert and communicated to an employee of a financial institution, an investigative business, or a governmental entity that monitors transactions to detect transaction structuring, payment layering, or other money laundering activity. The risk level may be communicated in any suitable format. For example, the risk level may include a risk category (e.g., (high, medium, low) or (red, yellow, green) or (A, B, C)) and/or a numerical value indicating a level of risk. The risk level may be communicated with any suitable information about the parties and/or transactions associated with the risk level, In some embodiments, the risk level may be ranked with respect to risk levels associated with other transactions and/or other parties in order to prioritize risks and determine where further investigation is needed. In some embodiments, the risk level may be enriched according to human intelligence. For example, if a bank teller observes a customer behaving suspiciously, the bank teller can increase the risk level. The method then ends.

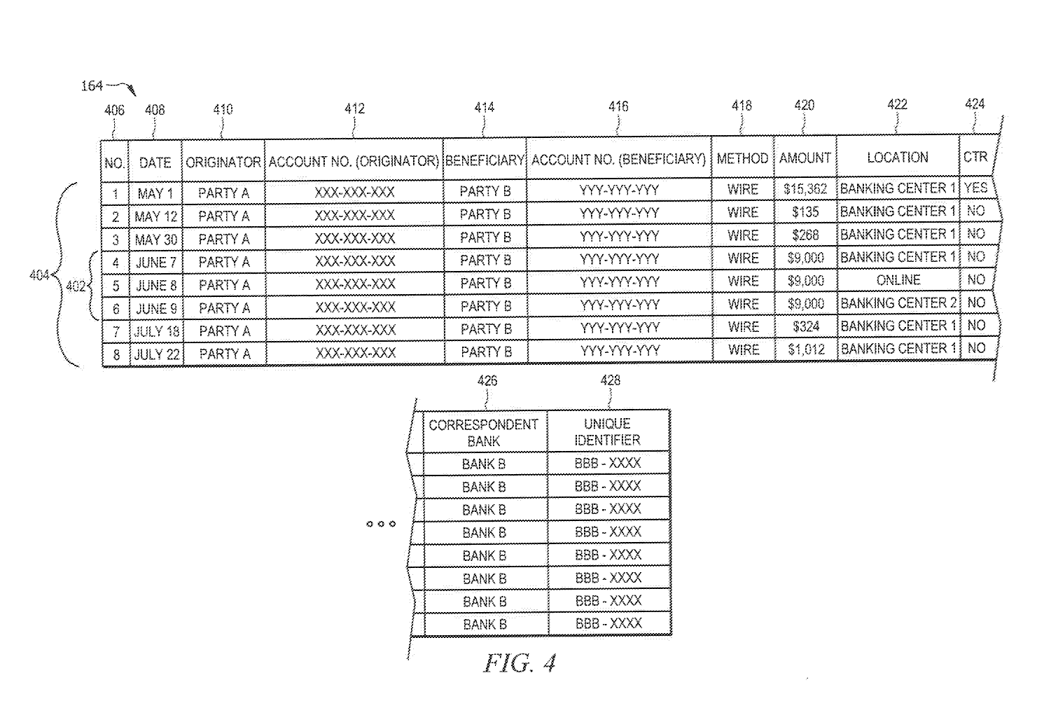

FIG. 4 illustrates an example of transaction history 164 that may be analyzed to determine whether the party (or parties) has demonstrated a pattern of activity consistent with transaction structuring or payment layering. Transaction history 164 may include transactions occurring during an alert period 402 and during a review period 404. In the example, transaction no. 5 may correspond to the transaction that triggers a potential alert on June 8. Alert period 402 may be configured to monitor transactions within one consecutive business day before and after transaction no. 5 (June 7 through June 9), and review period may be configured to monitor transactions within two months before and. after transaction no. 5 (April 7 through August 7).

Each transaction listed in transaction history 164 may include a transaction number 406, the date of the transaction 408, an originator identifier 410 indicating the party that originated the transaction, an account number 412 associated with the originator identifier 410, a beneficiary identifier 414 indicating the party that was the beneficiary of the transaction, an account number 416 associated with the beneficiary identifier 414, a method of the transaction 416, a monetary amount 420, a location 422 where the transaction was initiated, a report indicator 424 indicating whether or not the transaction triggered the filing of a CRT or other report, a correspondent bank name 426, a unique identifier 42$, and/or other suitable information.

Monitoring may be applied to transaction history 164 to detect suspicious activity. An example of monitoring may include applying weighting factors to determine a risk level that suspicious activity, such as transaction structuring or payment layering, occurred during alert period 402. As examples, in FIG. 4, the non-reported transaction weighting factor may be configured to increase the risk because the three transactions that occurred during alert period 402 were in the amount of $9,000 (just under the $10,000 CRT reporting limit), the even amount weighting factor may be configured to increase the risk because the three transactions each end in three zeros, and the location weighting factor may be configured to increase the risk because the three transactions were initiated form three separate locations (banking center 1, online, and banking center 2). Other weighting factors may apply depending on various implementations and configurations of the weighting factors.

Certain embodiments of the present disclosure may provide one or more technical advantages. A technical advantage of one embodiment includes accurately and efficiently detecting payment layering through correspondent banks. For example, certain embodiments may assign a unique identifier to a non-customer that accesses a financial institution's resources through a correspondent bank, The financial institution uses the unique identifier to monitor transactions by the non-customer. Thus, the financial institution may detect when the non-customer uses the financial institution's resources to make suspicious transactions. A technical advantage of one embodiment includes comparing the non-customer's current and historic behavior to determine whether a suspicious change in behavior has occurred. Certain embodiments of the present disclosure may include some, all, or none of the above advantages. One or more other technical advantages may be readily apparent to those skilled in the art from the figures, descriptions, and claims included herein.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document. “each” refers to each member of a set or each member of a subset of a set.

Modifications, additions, or omissions may be made to the methods described herein without departing from the scope of the invention, For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

What is claimed is:

1. A system, comprising:
an interface operable to receive transaction information for one or more transactions associated with an originating party, the one or more transactions performed using resources of a first financial institution; and
one or more processors communicatively coupled to the interface, the one or more processors are operable to:
determine that the originating party is not a customer of the first financial institution;
determine that the originating party is a customer of a second financial institution, the second financial institution authorized to facilitate access to the resources of the first financial institution;
assign a unique identifier to the originating party;
associate the one or more transactions with the unique identifier; and
monitor the one or more transactions based on a policy that the first financial institution applies to its own customers, the policy configured to:
determine a subset of the one or more transactions transacted between the originating party and a same beneficiary party during an alert period; and
generate an alert if an aggregate monetary value associated with the subset of transactions exceeds an alert threshold;
the interface further operable to communicate the alert.

2. The system of claim 1, the one or more processors configured to dynamically determine the alert period according to a number of consecutive business days that the transactions were transacted between the originating party and the same beneficiary party.

3. The system of claim 1, the policy further configured to suppress the alert if a recent transaction between the originating party and the same beneficiary party exceeded a reportable monetary amount, wherein the recent transaction occurred within a pre-determined recent time period.

4. The system of claim 1, wherein a portion of the unique identifier indicates that the originating party is a customer of the second financial institution.

5. The system of claim 1, wherein to associate the one or more transactions with the unique identifier, the one or more processors are operable to:
monitor a plurality of correspondent bank transactions that customers of the second financial institution perform using resources of the first financial institution;
determine a party name for each correspondent bank. transaction; and
associate the each correspondent hank transaction with the unique identifier if the party name corresponds to the originating party.

6. The system of claim 1, the policy further configured to generate an alert if:
a frequency of transactions between the originating party and the same beneficiary party during the alert period exceeds a frequency of transactions between the originating party and the same beneficiary party during a review period by a first pre-determined factor; and
an average monetary amount transacted between the originating party and the same beneficiary party per an averaging period during the alert period exceeds an average monetary amount transacted between the originating party and the same beneficiary party per the averaging period during the review period by a second pre-determined factor.

7. The system of claim 1, the one or more processors further operable to store the unique identifier and assign the unique identifier to a future transaction associated with the originating party.

8. Non-transitory computer readable medium comprising logic, the logic, when executed by a processor, operable to:
receive transaction information for one or more transactions associated with an originating party, the one or more transactions performed using resources of a first financial institution;
determine that the originating party is not a customer of the first financial institution;
determine that the originating party is a customer of a second financial institution, the second financial institution authorized to facilitate access to the resources of the first financial institution;
assign a unique identifier to the originating party;
associate the one or more transactions with the unique identifier;
monitor the one or more transactions based on a policy that the first financial institution applies to its own customers, the policy configured to:
determine a subset of the one or more transactions transacted between the originating party and a same beneficiary party during an alert period; and
generate an alert in response to detecting suspicious activity during the alert period; and
communicate the alert.

9. The computer readable medium of claim 8, the logic further operable to dynamically determine the alert period according to a number of consecutive business days that the transactions were transacted between the originating party and the same beneficiary party.

10. The computer readable medium of claim 8, the policy further configured to suppress the alert if a recent transaction. between the originating party and the same beneficiary party exceeded a reportable monetary amount, wherein the recent transaction occurred within a pre-determined recent time period.

11. The computer readable medium of claim 8, wherein a portion of the unique identifier indicates that the originating party is a customer of the second financial institution.

12. computer readable medium of claim 8, wherein to associate the one or more transactions with the unique identifier, the logic, when executed by a processor, is further operable to:
monitor a plurality of correspondent bank transactions that customers of the second financial institution perform using resources of the first financial institution;
determine a party name for each correspondent bank transaction; and
associate the each correspondent bank transaction with the unique identifier if the party name corresponds to the originating party.

13. The computer readable medium of claim 8, the policy further configured to generate an alert if:
a frequency of transactions between the originating party and the same beneficiary party during the alert period exceeds a frequency of transactions between the originating party and the same beneficiary party during a review period by a first pre-determined factor; and
an average monetary amount transacted between the originating party and the same beneficiary party per an averaging period during the alert period exceeds an average monetary amount transacted between the originating party and the same beneficiary party per the averaging period during the review period by a second pre-determined factor.

14. The computer readable medium of claim 8, the logic further operable to store the unique identifier and assign the unique identifier to a future transaction associated with the originating party.

15. A method, comprising:
receiving transaction. information for one or more transactions associated with an originating party, the one or more transactions performed using resources of a first financial institution;
determining that the originating party is not a customer of the first financial institution;
determining that the originating party is a customer of a second financial institution, the second financial institution authorized to facilitate access to the resources of the first financial institution;
assigning a unique identifier to the originating party;
associating the one or more transactions with the unique identifier;
monitoring, by one or more processors, the one or more transactions based on a policy that the first financial institution applies to its own customers, the policy configured to:
determine a subset of the one or more transactions transacted between the originating party and a same beneficiary party during an alert period; and
generate an alert if an aggregate monetary value associated with the subset of transactions exceeds an alert threshold; and
communicating the alert.

16. The method of claim 15, further comprising dynamically determining the alert period according to a number of consecutive business days that the transactions were transacted between the originating party and the same beneficiary party.

17. The method of claim 15, the policy further configured to suppress the alert if a recent transaction between the originating party and the same beneficiary party exceeded a reportable monetary amount, wherein the recent transaction occurred. within a pre-determined recent time period.

18. The method of claim 15, wherein a portion of the unique identifier indicates that the originating party is a customer of the second financial institution.

19. The method of claim 15, associating the one or more transactions with the unique identifier comprises:
monitoring a plurality of correspondent bank transactions that customers of the second financial institution perform using resources of th.e first financial institution;
determining a party name for each correspondent bank transaction; and
associating the each correspondent bank transaction with the unique identifier if the party name corresponds to the originating party.

20. The method of claim 15, the policy further configured to generate an alert if:
a frequency of transactions between the originating party and the same beneficiary party during the alert period exceeds a frequency of transactions between the originating party and the same beneficiary party during a review period by a first pre-determined factor; and
an average monetary amount transacted between the originating party and the same beneficiary party per an averaging period during the alert period exceeds an average monetary amount transacted between the originating party and the same beneficiary party per the averaging period during the review period by a second pre-determined factor.
